(19) United States
(12) Patent Application Publication
(10) Pub. No.: US 2020/0310828 A1
(43) Pub. Date: Oct. 1, 2020

(54) METHOD, FUNCTION MANAGER AND ARRANGEMENT FOR HANDLING FUNCTION CALLS

(71) Applicant: Telefonaktiebolaget LM Ericsson (publ), Stockholm (SE)

(72) Inventors: Daniel TURULL, SOLNA (SE); Joacim HALÉN, SOLLENTUNA (SE); Vinay YADHAV, UPPLANDS VÄSBY (SE)

(21) Appl. No.: 16/768,571

(22) PCT Filed: Dec. 13, 2017
(86) PCT No.: PCT/SE2017/051260

§ 371 Date: May 29, 2020

(51) Int. Cl. G06F 9/448; G06F 9/54; G06F 9/50

(52) U.S. Cl. CPC G06F 9/4486; G06F 9/505; G06F 9/542; G06F 9/547

(57) ABSTRACT

A first function manager and a method performed therein for handling a call of a second function from a first function. According to the method the first function manager obtains information associated with one or more locations of the second function. The first function manager also determines an availability of the second function at the one or more locations, based on the obtained information and selects one of the one or more locations for forwarding the call of the second function from the first function. I further step, the first function manager forwards the call of the second function from the first function.

### TECHNICAL FIELD

The present disclosure relates to a function manager and an arrangement, and methods therein, for handling function calls from one function to another.

### BACKGROUND

A recent addition to the cloud computing services available to application developers is the so-called Function as a Service (FaaS). FaaS provides to the application developer, such as a computer programmer writing source code for application software, a “server-less” computing architecture, in which the complexity of the service infrastructure is hidden. The developer defines the application as a set of functions which are, e.g., uploaded or by other means delivered to the provider of the service for subsequent deployment in an execution environment.

A FaaS execution platform typically includes multiple hosts, also called worker nodes, onto which execution environments and application functions are deployed. The platform also includes a gateway and load balancer, for receiving function triggering events and distributing the load among the hosts, and additionally a common storage for the multiple hosts.

In a typical scenario, the gateway receives an event that triggers the launch of a function which is then scheduled on one of the hosts through the load balancer. When a function is invoked for the first time, the host deploys the execution environment of the function and then deploys, i.e., loads, the function into the execution environment. On a subsequent invocation, the host may instead resume the execution environment of the function. Next, the function is executed and a result is returned. If a function is called within the function executing, whether or not the function calls itself or a different function, the request is forwarded to the gateway and processed further as described above.

Compared to the traditional server based architecture, the described Function as a Service has the advantage that applications can scale up and down depending on the load without the need to start new servers. However, scheduling function calls through a load balancer may cause significant delays in the execution of a function.

### SUMMARY

It is an object of embodiments described herein to address at least some of the problems and issues outlined above. It is possible to achieve this object and others by using methods, function manager and arrangement as defined in the attached independent claims.

According to one aspect, there is provided a method is performed by a first function manager for handling a call of a second function from a first function. In one step of the method the first function manager obtains information associated with one or more locations of the second function and in another step determines an availability of the second function at the one or more locations, based on the obtained information. In the method, the first function manager also selects one of the one or more locations for forwarding the call of the second function from the first function. In one further step of the method, the first function manager forwards the call of the second function from the first function. Optionally, the first function manager may in a further step of the method intercept the call from the first function.

According to another aspect, there is provided a first function manager for handling a call of a second function from a first function. The first function manager is operable to obtain information associated with one or more locations of the second function and is further operable to determine an availability of the second function at the one or more locations, based on the obtained information.

The first function manager is also operable to select one of the one or more locations for forwarding the call of the second function from the first function and operable to forward the call of the second function from the first function. According to one aspect, there is provided a method is performed by an arrangement for handling a call of a second function from a first function. In one step of the method information associated with one or more locations of the second function is obtained, and in another step it is determined an availability of the second function at the one or more locations, based on the obtained information. Also according to the method, in one step it is selected one of the one or more locations for forwarding the call of the second function from the first function, and in a further step the call of the second function from the first function is forwarded. The above steps may be performed by a first function manager optionally comprised in the arrangement.

The method may optionally comprise in one further step that a function call for the second function is received, and in another further step that the function call is forwarded to the second function. These two further steps may be performed by a second function manager optionally comprised in the arrangement.

According to another aspect, there is provided an arrangement for handling a call of a second function from a first function. The arrangement is operable to obtain information associated with one or more locations of the second function, and determine an availability of the second function at the one or more locations, based on the obtained information. The arrangement is also operable to select one of the one or more locations for forwarding the call of the second function from the first function, and forward the call of the second function from the first function. The arrangement may be operable to perform the above actions at a first function manager optionally comprised in the arrangement.

The arrangement may further be operable to receive the function call for the second function, and forward the function call to the second function. The arrangement may be operable to perform the above further actions at a second function manager optionally comprised in the arrangement.

The above methods and apparatuses may be configured and implemented according to different optional embodiments to accomplish further features and benefits, to be described below.

A computer program is also provided which comprises instructions which, when executed on at least one processor, cause the at least one processor to carry out either of the methods described above. A computer program product comprising a computer-readable medium having stored there on the above computer program is also provided. A program carrier containing the above computer program is further provided, wherein the program carrier is one of an electronic signal, an optical signal, a radio signal, or a computer readable storage medium.

Advantageously, certain embodiments herein provide less latency when executing a function. Furthermore, some embodiments provide the possibility to select an optimal location for executing function called from another function, which may be based on further, or other, information than is available to a gateway and/or a load balancer.

### BRIEF DESCRIPTION OF DRAWINGS

The solution will now be described in more detail by means of exemplary embodiments and with reference to the accompanying drawings, in which:

FIG. 1 illustrates schematically a block diagram of an exemplary arrangement for providing FaaS, according to a particular embodiment.

FIG. 2A-D are flowcharts for handling a function call, in accordance with particular embodiments.

FIG. 3 is a flowchart for handling a function call, in accordance with a further particular embodiment.

FIG. 4 illustrates a schematic block diagram illustrating the functional units used in handling a function call, according to particular embodiments.

FIG. 5 is a flowchart for handling a function call, in accordance with a further particular embodiment.

FIG. 6 is a flowchart for handling a function call, in accordance with a further particular embodiment.

FIG. 7 is a flowchart for handling a function call, in accordance with another particular embodiment.

### DETAILED DESCRIPTION

Briefly described, a solution is provided to enable more efficient handling of function calls on an execution platform, for instance hosting a service such as Function as a Service.

The next development stage in data centers is so called server-less computation. The developer defines the applications to be executed in an execution platform, e.g., in a data center, as a set of functions with access to a common store. The functions are stateless and mostly share information through the common store. These functions are called after they are trigger by an event or by another function. A common name for this model of programming is Lambda (from Amazon-Lambda), or Function as a Service (FaaS) model.

Typically, the functions are deployed inside a runtime environment, i.e. the execution environment provided to the function. Before deploying the functions, the runtime environment is deployed on a host, or worker node, managed by the provider of the service. The worker node can thus load functions provided by a customer to the service and scale resources up/down on demand depending on the load. The runtime environment may for example be deployed inside OS containers, which provides isolation between customers, also called tenants. The function may comprise software code of one or more programming languages, and provide or perform specific task(s) when executed.

The Lambda model has several advantages in cloud deployment in comparison to server based architectures, such as that different costumers/tenants share common pools of servers managed by the provider, which remove the management of the infrastructure from the developers of the functions. Another advantage is that resources needed for executing applications, such as processing units, memory, etc., can scale up and down without the need to start new servers. Additionally, since the runtime environment is shared, the code specific to an application will be small, and therefore easy to transfer between worker nodes.

A typical environment known in the state of the art for server-less an execution platform, has the following flow.

1. The service gateway receives an event, which triggers a launch, i.e., deployment and execution, of a function.

2. The function is scheduled through the load balancer on a worker node.

3. On first invocation of function, the worker node deploys the execution environment (normally in a container) of the function. On a subsequent invocation, the worker node resumes the execution environment of the function.

4. The worker node loads function.

5. The worker node executes function.

6. Finally, the worker node returns the result to the requester.

The load balancer may perform the following steps:

1. When receiving a scheduling event, it checks if the function is already deployed on any worker node.

2a. If finding a worker node that has sufficient capacity to execute the function, it executes the function, using any provided arguments to the function, on that worker node.

2b. If the function is not already deployed, or there is not sufficient capacity to execute the function, it deploys and executes the function on a new worker node.

When a function inside FaaS needs to call other FaaS functions to perform its work, the function call—the term “call” is also used herein for brevity—needs to be sent as a request to the service gateway and the process starts over again as described above. The advantage of this procedure is its simplicity, however, at the same time it has a considerable latency overhead.

According to embodiments herein, the execution of the function may instead be performed in the same execution environment or on the same host.

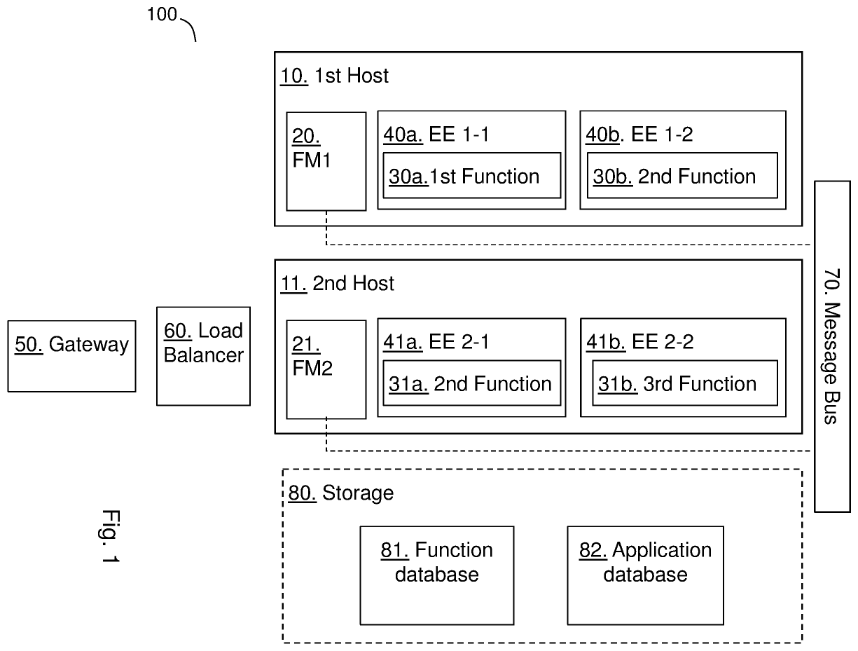

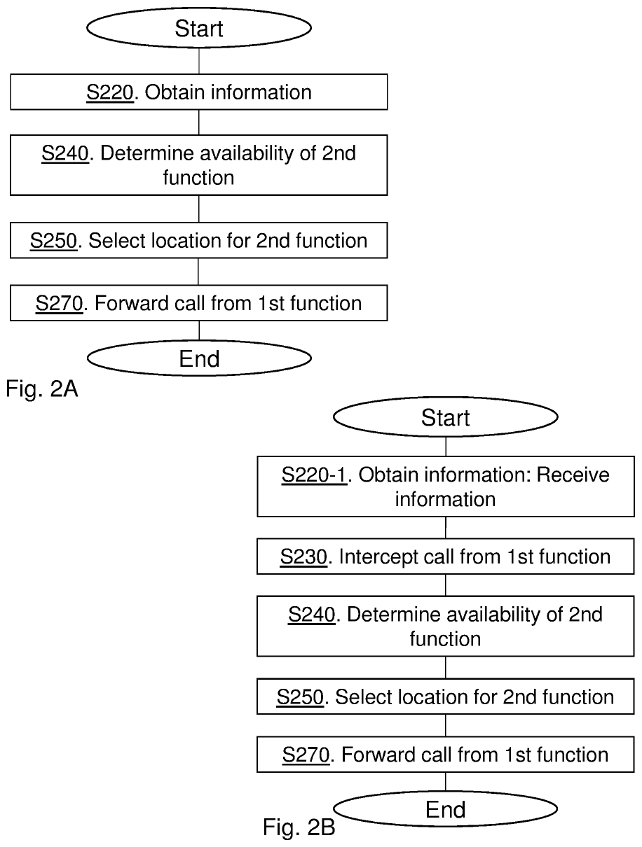

FIG. 1 illustrates an exemplary system 100 comprising a first function manager 20 and a second function manager 21 for handling a function call. Embodiments of the function manager as disclosed herein will be described in further detail below. The system may as an example be located in a datacenter providing a service such as FaaS. The system comprises a first host 10 and a second host 11, each associated with a function manager: first function manager 20 and second function manager 21, respectively, which may communicate via a message bus 70. Each host 10, 11 may comprise a number of execution environments (EE) 40a, 40b, 41a, 41b, deployed by the first host 10 and second host 11, respectively. Illustrated in FIG. 1 is also that each EE 40a, 40b, 41a, 41b, may have at least one function 30a, 30b, 31a, 31b loaded therein. Additionally, the system may comprise a gateway 50 for receiving function triggering events, and load balancer 60 for distributing the load among the hosts, and may further comprise a common storage 80, which contains a function database 81 for storing functions, e.g. uploaded by tenants, and an application database 82.

A system for handling the function call may have a different architecture than illustrated by FIG. 1, including various other software and hardware components not show in FIG. 1. As used herein, the “first function manager” is associated with the “first host”, and the first host is associated with the “first function”, and, particularly, the first function may be deployed on the first host. Further, the term “second function manager” as used herein denotes a function manager associated with any other host than the first host. Hence in an arrangement comprising further hosts, a second function manager may be associated with each further host or each of a subset the further hosts. Each such second function manager may thus be located on the further host, with which it is associated.

Furthermore, “second function” as used herein denotes a function performing a specific task, i.e., a second function deployed on a first host performs the same task as a second function deployed on a second host. Second functions, independently of their location, are thus equivalent in their function, and therefore produce the same result, or output, when executed using the same input, e.g., parameters.

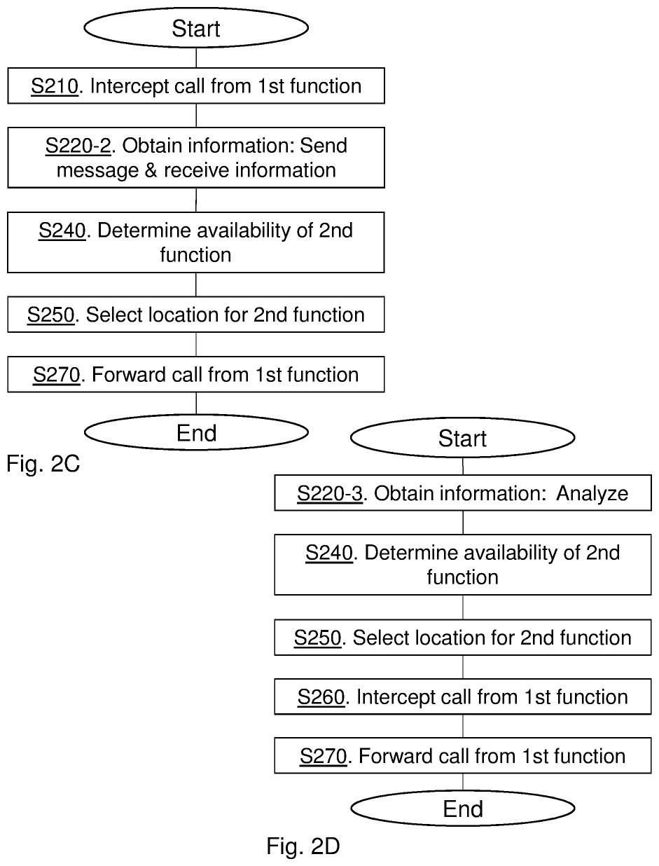

An example of how the solution may be employed will now be described with reference to the flowchart in FIG. 2A illustrating the steps of an embodiment of a method for handling a function call of a second function from a first function implemented in a first function manager (FM), and with further reference to FIG. 1 although the first function manager is not limited to such a system 100.

In step S220 the first function manager (FM1) 20 obtains information associated with one or more locations of the second function. Referring to FIG. 1, FM1 20 may e.g. obtain information that the second function 30b is located on the same host, the first host 10, but in a different execution environment 40b. FM1 may additionally or alternatively obtain information that the second function 31a is located on a different host, the second host 11.

Based on the obtained information, the first function manager in step S240 determines an availability of the second function at the one or more locations. The first function manager may for instance determine if the capacity at a particular location is sufficient to execute the function, e.g., that the CPU load on a host is not excessive or that there is enough memory. Another example is that the first function manager may determine that a capacity on the message bus 70 is sufficient, which may be relevant e.g. when the called second function is located on a different host than the first function.

Having determined the availability of the second function, the first function manger in step S250 selects one of the one or more locations for forwarding the call of the second function from the first function, and in step S270 the first function manager forwards the call of the second function from the first function.

In some embodiments, the method further comprises the first function manager intercepting the call from the first function. In this way, the first function manager may obtain information about which function is called by the first function. In one particular example, the first function manager, by intercepting the call from the first function, obtains information that the second function is called from the first function.

FIGS. 2B-D show some further embodiments comprising the first function manager intercepting the call from the first function in steps S230, S210 and S260, respectively. Steps S240, S250 and S270 have been described above in connection with FIG. 2A and some further aspects in connection with the embodiments of FIGS. 2B-D are described below.

In the embodiment illustrated by FIG. 2B, the first function manager in step S230 intercepts the call after obtaining information associated with one or more locations of the second function in step S220-1. According to this embodiment, the first function manager may thus obtain information by receiving the information on the location(s) of the second function, for example from a second function manager. This may be the case when the second function manager registers the second function when the function has finished executing on the second host associated with the second function manager, and the function is in status paused. This may thus indicate to the first function manager that the second function is available to execute, if called from the first function executing on the first host.

In one particular embodiment, determining an availability of the second function at the one or more locations in step S240 comprises one or more of determining a workload of a host onto which one of the second function at the one or more locations is deployed, determining a distance between the one or more locations of the second function and a location of the first function, and determining an access time associated with a host onto which one of the second function at the one or more locations is deployed.

In one particular embodiment, the first function manager forwards in step S270 the call of the second function from the first function to a second function manager. As described above, the first function manager may obtain information that the called second function is located on another host than the first function and may in that case forward the call to a second function manager located on or associated with that other host.

Obtaining information associated with one or more locations of the second function in step S220 may in one particular embodiment comprise storing information associated with a location of the second function. As will be described below, this information may be obtained by different means.

The information may be obtained within the first host. For example, when a second function is deployed on the first host, the first function manager, or another entity aware of the deployment of the second function, may store the information.

In one particular embodiment, determining an availability of the second function at the one or more locations in step S240 comprises retrieving the stored information associated with a location of the second function.

I another particular embodiment, the step S220 of obtaining information associated with one or more locations of the second function comprises receiving information associated with a location of the second function. As described above, this may be the result of the second function manager registering the second function. Thus, obtaining information associated with one or more locations of the second function may comprise receiving information associated with a location of the second function from one or more second function managers.

In one further embodiment, the step S220 of obtaining information associated with one or more locations of the second function comprises sending a message associated with the second function to at least one second function manager. In one embodiment, sending a message associated with the second function comprises broadcasting said message. The sent message or broadcast message may for example be a query message associated with the second function, e.g., a message comprising a query whether the second function is deployed.

As illustrated in FIG. 2C, the first function manager may thus in step S220-2 obtain information by sending a message, asking for locations of the second function, and may receive a response from a second function manager. As described above, the first function manager may obtain information by broadcasting said message, and may then receive responses from one or more second function managers. In this embodiment, the first function manager may therefore as shown in FIG. 2C in step S210 intercept the call from the first function before obtaining information associated with one or more locations of the second function.

In a further particular embodiment, obtaining information associated with one or more locations of the second function in step S220 comprises analyzing the first function for determining a dependency on the second function. By analyzing the first function, it may be determined what other functions are called from the first function. Determining a dependency on the second function may thus comprise determining whether a second function is called from the first function. As one example, the complete first function may be analyzed to determine all function calls in the first function and what functions that are called, e.g., a second function, a third function, etc. It may further be analyzed what functions are called by, e.g., one or more of the second function, third function, etc., to determine a larger subset, or even the complete set, of the functions called during the execution of the first function.

FIG. 2D shows an exemplary embodiment, wherein obtaining information in step S220-3 includes analyzing the first function. By this analysis the location of the second function may be selected in advance of an actual function call, e.g., well before the first function calls the second function. In this embodiment, the first function manager may thus in step S260 intercept the call from the first function after selecting a location of the second function, for example merely to find out which function is called and forward the call from the first function.

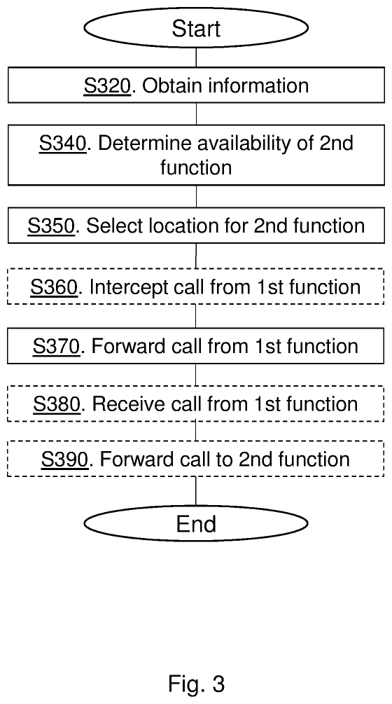

FIG. 3 illustrates an embodiment of a method performed by an arrangement for handling a call of a second function from a first function. In step S320 the arrangement obtains information associated with one or more locations of the second function, and determines in step S340 an availability of the second function at the one or more locations, based on the obtained information. The arrangement in step S350 selects one of the one or more locations for forwarding the call of the second function from the first function and in step S370 forwards the call of the second function from the first function. These steps may be performed by a first function manager optionally comprised in the arrangement. In further optional steps, the arrangement receives in step S380 the function call for the second function, and in step S390 forwards the function call to the second function. These steps may be performed by a second function manager optionally comprised in the arrangement.

In one embodiment, the arrangement may additionally intercept S360 the call of the second function from the first function, e.g., to determine what function is called in the function call. This step may be performed by the first function manager optionally comprised in the arrangement.

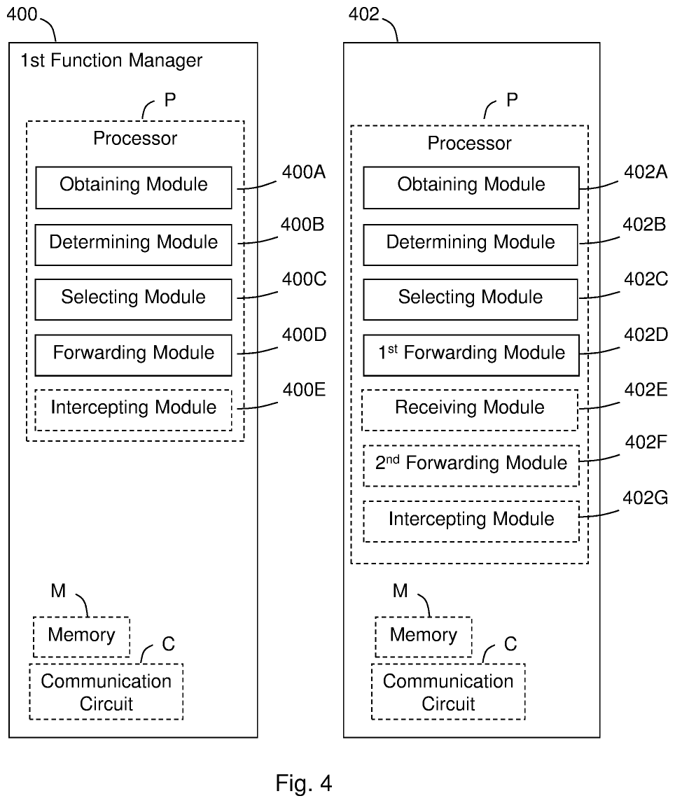

The block diagram in FIG. 4 illustrates a detailed but non-limiting example of how a first function manager 400 and an arrangement 402, respectively, may be structured to bring about the above-described solution and embodiments thereof. In this figure, the first function manager 400 and the arrangement 402 may be configured to operate according to any of the examples and embodiments of employing the solution as described herein, where appropriate. For example, in the manner described above for either of FIGS. 2A-D and FIG. 3. The first function manager 400 and the arrangement 402 are shown to comprise a processor “P”, a memory “M” and a communication circuit “C” with suitable equipment for sending and receiving information and messages in the manner described herein.

The communication circuit C in the first function manager 400 thus comprises equipment configured for communication with other function managers using suitable technologies and protocols for the communication depending on the implementation. The solution is however not limited to any specific types of technologies and protocols.

The first function manager 400 is, e.g. by means of units, modules or the like, configured or arranged to perform the steps S220, S240, S250 and S270 of the flowchart in FIG. 2A and as follows.

The first function manager 400 is arranged for handling a function call of a second function from a first function. The first function manager 400 is configured to obtain information associated with one or more locations of the second function. This operation may be performed by an obtaining unit 400A in the first function manager 400, and as illustrated in step S220.

The first function manager 400 is also configured to determine an availability of the second function at the one or more locations, based on the obtained information. This operation may be performed by a determining unit 400B in the first function manager 400, and as illustrated in step S240.

The first function manager 400 is further configured to select one of the one or more locations for forwarding the call of the second function from the first function. This operation may be performed by a selecting unit 400C in the first function manager 400, and as illustrated in step S250.

The first function manager 400 is further configured to forward the call of the second function from the first function. This operation may be performed by a forwarding unit 400D in the first function manager 400, and as illustrated in step S270.

In some particular embodiments, the first function manager 400 is further configured to intercept the call of the second function from the first function. This operation may be performed by an optional intercepting unit 400E in the first function manager 400, and as illustrated in FIG. 2B step S230, FIG. 2C step S210, and FIG. 2D step S260, respectively.

The arrangement 402 is, e.g. by means of units, modules or the like, configured or arranged to perform the steps S320, S340, S350 and S370, and optionally steps S360, S380, and S390 of the flowchart in FIG. 3 and as follows.

The arrangement 402 is operable for handling a function call of a second function from a first function. The arrangement 402 is operable to obtain information associated with one or more locations of the second function. This operation may be performed by an obtaining unit 402A in the arrangement 402, and as illustrated in step S320.

The arrangement 402 is also operable to determine an availability of the second function at the one or more locations, based on the obtained information. This operation may be performed by a determining unit 402B in the arrangement 402, and as illustrated in step S340.

The arrangement 402 is further operable to select one of the one or more locations for forwarding the call of the second function from the first function. This operation may be performed by a selecting unit 402C in the arrangement 402, and as illustrated in step S350.

The arrangement 402 is further operable to forward the call of the second function from the first function. This operation may be performed by a first forwarding unit 402D in the arrangement 402, and as illustrated in step S370.

The arrangement 402 may further be operable to receive the call of the second function from the first function. This operation may be performed by an optional receiving unit 402E in the arrangement 402, and as illustrated in step S380.

The arrangement 402 may further be operable to forward the call of the second function from the first function to the second function. This operation may be performed by an optional second forwarding unit 402F in the arrangement 402, and as illustrated in step S390.

In some particular embodiments, the arrangement 402 is further operable to intercept the call of the second function from the first function. This operation may be performed by an optional intercepting unit 402G in the arrangement 402, and as illustrated in step S360.

In one embodiment, the arrangement 402 comprises a first function manager, a second function manager and a message bus, and is further operable to communicate between the first function manager and the second function manager via the message bus.

It should be noted that FIG. 4 illustrates various functional units in the first function manager 400 and the arrangement 402, respectively, and the skilled person is able to implement these functional modules in practice using suitable software and hardware equipment. Thus, the solution is generally not limited to the shown structures of the first function manager 400 and the arrangement, and the functional units therein may be configured to operate according to any of the features, examples and embodiments described in this disclosure, where appropriate.

The functional units 400A-E and 402A-G described above may be implemented in the first function manager 400 and arrangement 402, respectively, by means of program modules of a respective computer program comprising code means which, when run by the processor P causes the first function manager 400 and the arrangement 402 to perform the above-described actions and procedures.

Each processor P may comprise a single Central Processing Unit (CPU), or could comprise two or more processing units. For example, each processor P may include a general purpose microprocessor, an instruction set processor and/or related chips sets and/or a special purpose microprocessor such as an Application Specific Integrated Circuit (ASIC). Each processor P may also comprise a storage for caching purposes.

Each computer program may be carried by a computer program product in each of the first function manager 400 and the arrangement 402 in the form of a memory having a computer readable medium and being connected to the processor P. The computer program product or memory M in each of the first function manager 400 and the arrangement 402 thus comprises a computer readable medium on which the computer program is stored e.g. in the form of computer program modules or the like. For example, the memory M in each node may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the respective first function manager 400 and arrangement 402.

The solution described herein may be implemented in each of the first function manager 400 and the arrangement 402 by a computer program comprising instructions which, when executed on at least one processor, cause the at least one processor to carry out the actions according to any of the above embodiments and examples, where appropriate. The solution may also be implemented at each of the first function manager 400 and the arrangement 402 in a computer program product comprising a computer-readable medium having stored there on the above computer program. The solution may also be implemented at each of the first function manager 400 and the arrangement 402 in a program carrier containing the above computer program, wherein the program carrier is one of an electronic signal, optical signal, radio signal, or computer readable storage medium.

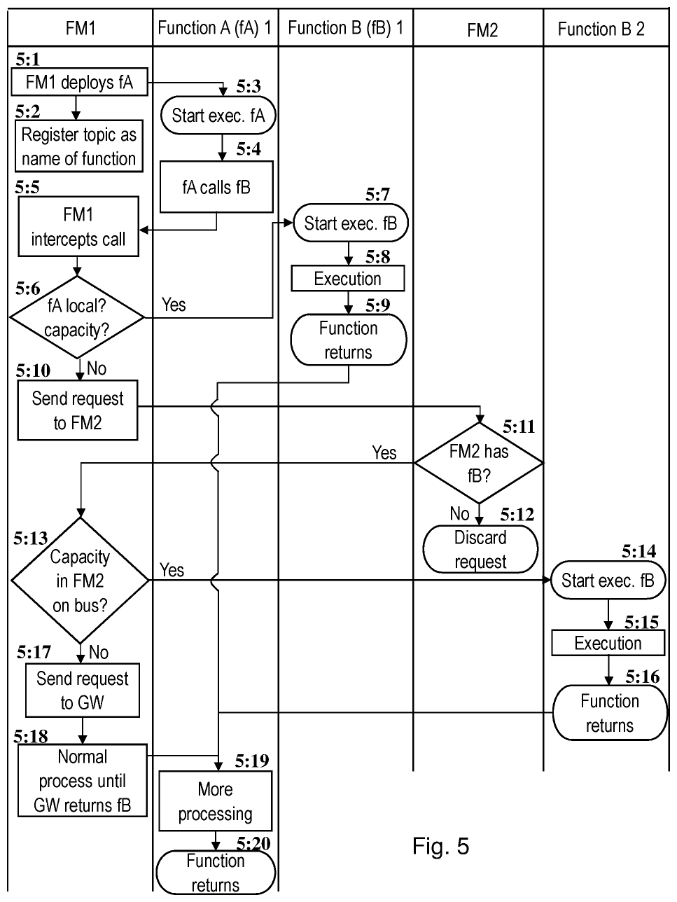

An example of a procedure when the solution is used will now be described with reference to the flow chart in FIG. 5 involving a first function manager (FM) 1, FM1, and a second function manager, FM2. FM1 is associated with a first function, Function A (fA) 1, and a second function, Function B (fB) 1. FM2 is associated with a second function, Function B 2. As described above, each second function performs the same task.

FM1 and FM2 are in this example interconnected via a message bus. In practice, several function managers may be interconnected to form a cluster. In an action 5:1, FM1 deploys fA and, in action 5:2, registers a topic under the name of the function, if it does not exist, and subscribes to it. When the function later is stopped, FM1 unregisters from that function topic. When the function is in status STOP, its execution environment is removed from memory but it is kept on the disk of the local machine.

In an action 5:3, FM1 starts executing fA and, at some stage during execution, fA calls a second function, fB, in an action 5:4. This call is in action 5:5 intercepted by FM1, which may enable FM1 to determine the name of the called function.

Subsequently, in action 5:6 FM1 obtains information associated with one or more locations of fB. FM1 may for example obtain information that fB is deployed locally, i.e. on the same host as fA. FM1 next determines the availability of fB based on the information it obtained and may thereafter select one of the locations. As an example, FM1 may determine whether sufficient capacity is available to execute the function on the location. When having selected a location, FM1 forwards the function call from fA to fB.

When FM1 has selected the locally deployed fB, this function is executed in action 5:7 and action 5:8, and eventually returns to fA in action 5:9, when fB has finished executing, whereby fA continues processing in action 5:19, and fA returns to the requester in action 5:20. Alternatively, FM1 may select another location of fB, for example if fB is not locally deployed or there is not sufficient capacity for executing fB locally. In this case FM1 therefore in action 5:10 sends a request for execution to other function managers that are listening to the topic of such a function, i.e. with the name fB, which here is illustrated by a second function manager, FM2.

In action 5:11 FM2 determines whether fB is locally deployed. If not, FM2 discards the request in action 5:12, and in the alternate, responds to FM1. FM1 may receive multiple answers, i.e. an answer from multiple function managers, and uses in action 5:13 the obtained information to determine the availability of fB. In this example, FM1 determines whether there is sufficient capacity in FM2 on the message bus and, if so, selects this location of fB and forwards the call from fA. fB is executed in action 5:14 and action 5:15, and eventually returns to fA in action 5:16, when fB has finished executing, whereby fA continues processing in action 5:19, and fA returns to the requester in action 5:20.

When FM1 instead in action 5:13 determines the availability, and finds that there is not sufficient capacity, FM1 in action 5:17 sends the request to the gateway and continues its normal processing in action 5:18 until the gateway returns a call for function fB. Hence FM1 may forward the request to the gateway in situations where no reply is received from other function managers, e.g. if no answer has been received within a predetermined amount of time, or the determined availability is not sufficient in some aspect, e.g. too low capacity to execute the function fB.

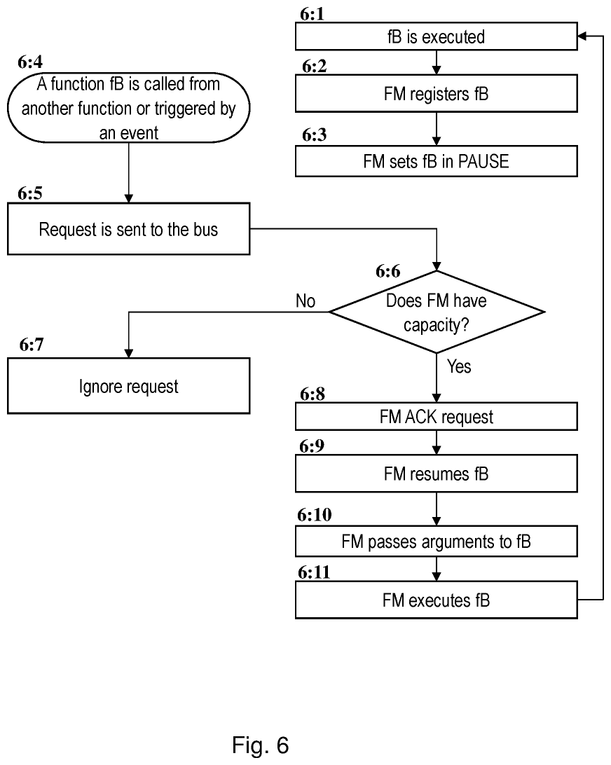

FIG. 6 illustrates an alternative example, wherein a function manager relies on the message bus for delivering a request. In action 6:1 a function fB is finished executing on a host and the function manager (FM) associated with the host registers fB in action 6:2 and further sets fB in PAUSE status in action 6:3. When the function is PAUSED, its execution environment is kept in memory of the local machine for future executions. Next, function fB is called from another function or triggered by an event in action 6:4 and a request is therefore sent to the message bus in action 6:5. In action 6:6 it is then checked whether the function manager that registered fB has capacity to execute the function. If not, the request is ignored in action 6:7, and otherwise FM acknowledges the request in action 6:8. The function manager will in the latter case resume fB in action 6:9, whereby the FM passes arguments to fB and executes fB in action 6:10 and action 6:11, respectively. When the execution of fB starts again, FM unregisters fB. According to this alternative, the request is only delivered to a function manager that has the requested function deployed and has the capacity to execute the function.

Functions often make calls to other functions that are either part of a library or function that are user defined. In order to be able to execute a function in a timely manner, the Function as a Service platform may need to schedule and launch all the functions in the chain of calls that can be made from the first function that is invoked. Determining the potential chain of functions that will be invoked as a result of executing a function may in some cases be important for ensuring timely completion of the function execution.

In the following, two methods are described for determining the chain of functions required to complete an action initiated as a result of invoking a function in FaaS platform.

The first method may be referred to as Static Function analysis for function and dependency placement. In this method a static analysis of a function that is uploaded by the tenant is relied on to determine all the other functions it depends on. The function that the uploaded function depends on can be functions that have been uploaded by the tenant or functions from the set of libraries provided as part of the FaaS platform. Once the dependency of an uploaded function is identified, a call graph for that function is derived and stored as a metadata and this information may then be used to optimally place the function when it needs to be invoked. Having a prior knowledge of where the dependency functions are loaded helps to choose a location that is cost effective in terms of time required to call functions and pass parameters or messages between them.

In one particular embodiment, the method is carried out when a function is uploaded to the FaaS. This involves a static analysis of the function code and creation of a call graph for the function which is stored as its metadata. The method comprises the following steps:

1. The tenant uploads a function to the FaaS platform.

2. The function is analyzed and calls to all other functions are determined, either library functions or tenant uploaded functions that could be invoked as a result of invoking the current function. This can be done by statically analyzing the function calls in a recursive manner, for example the deep first traversal of function calls.

3. A graph of the determined function calls is built. The details of each function are recorded, such as the resources utilized by them, where they are currently placed, what the average runtime is, etc.

4. The details of the function call graph are stored as meta-data associated with the function that the tenant uploaded.

Once the meta-data is stored it can be used when a function is invoked. The following steps show how the information in the function's metadata is used to place the function that needs to be invoked as well as some of its dependencies:

5. An external trigger initiates invocation of the function.

6. The function call graph is retrieved from the meta-data of the function.

7. For each function of the function call graph, classify into group of functions that have been already allocated and group of functions that have not been allocated, respectively.

8. Calculate possible location for launching the invoked function by considering the characteristics of the function from the already allocated function group. The characteristics to consider may be the location where the function is initiated, access time to the location where the function is running, the runtime of the function, etc.

9. Launch the invoked function in one of the possible locations identified along with the function in the not yet launched group.

The second method may be referred to as Dynamic Function analysis for function and dependency placement. In many cases determining the dependency of a function can be difficult before the function is initiated and hence static analysis of function code is ineffective in building a call graph for a function. The second method can in such cases be used to derive function dependency and build up a call graph for a function by learning over time how a function behaves and what other functions it calls. In this method the various functions that are called from an originally initiated function are recorded. The dependencies could vary from one invocation of the function to another; hence sufficient iterations of the function invocations are required to build up a meta-data for the call graph.

Once this learning method had sufficient consistent information about a functions dependency and the same as been recorded in the function metadata as a call graph, any future decisions of placing the function for a new invocation is taken based on the metadata as in the first method.

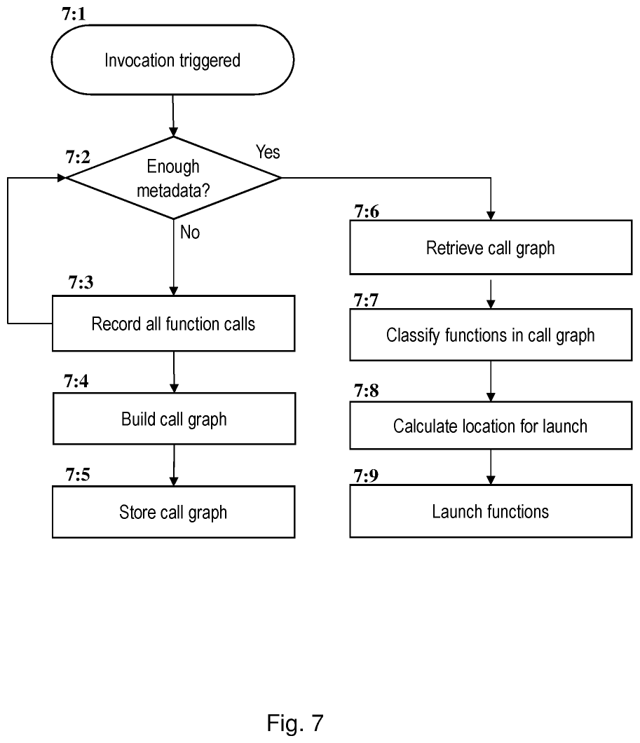

In one particular embodiment, as illustrated by FIG. 7, the second method comprises the following actions:

7:1 An external trigger initiates invocation of the function that has been uploaded by a tenant.

7:2 Next, it is determined whether there is enough meta-data on the function being invoked. If the answer is yes, the method continues with action 7:6 below.

7:3 If not enough meta-data, call to other functions or library functions in the context of execution of the original function are recorded, as well as their location, runtime of the function and access time to the function from the original function. This step is repeated for all functions called in the context of the initial function.

7:4 A function call graph is built for the initiated function with the information collected from analyzing the function being called in the context of the initial function.

7:5 The function call graph is stored along with characteristics of the functions in the meta-data associated with each of the functions in the call graph.

7:6 Retrieve the function call graph from the meta-data of the function.

7:7 For each function of the function call graph, classify into group of functions that have been already allocated and group of functions that have not been allocated, respectively.

7:8 Calculate possible location for launching the invoked function by considering the characteristics of the function from the already allocated function group. The characteristics to consider may be the location where the function is initiated, access time to the location where the function is running, the runtime of the function, etc.

7:9 Launch the invoked function in one of the possible locations identified along with the function in the not yet launched group.

While the solution has been described with reference to specific exemplifying embodiments, the description is generally only intended to illustrate and explain the solution and should not be taken as limiting the scope of the solution. For example, the terms “first function manager”, “second function manager”, “first function”, “second function”, “first host”, “second host” and “message bus” has been used throughout this disclosure, although any other corresponding entities, functions, and/or parameters could also be used having the features and characteristics described here. The solution is defined by the appended claims.

1. A method performed by a first function manager for handling a call of a second function from a first function, the method comprising:
obtaining information associated with one or more locations of the second function;
determining an availability of the second function at the one or more locations, based on the obtained information;
selecting one of the one or more locations for forwarding the call of the second function from the first function; and
forwarding the call of the second function from the first function.

2. The method according to claim 1 further comprising:
intercepting the call from the first function.

3. The method according to claim 1, wherein determining an availability of the second function at the one or more locations comprises one or more of determining a workload of a host onto which one of the second function at the one or more locations is deployed, determining a distance between the one or more locations of the second function and a location of the first function, and determining an access time associated with a host onto which one of the second function at the one or more locations is deployed.

4. The method according to claim 1, wherein forwarding the call of the second function from the first function comprises forwarding the call to a second function manager.

5. The method according to claim 1, wherein obtaining information associated with one or more locations of the second function comprises storing information associated with a location of the second function.

6. The method according to claim 5, wherein determining an availability of the second function at the one or more locations comprises retrieving the stored information associated with a location of the second function.

7. The method according to claim 1, wherein obtaining information associated with one or more locations of the second function comprises receiving information associated with a location of the second function.

8. The method according to claim 7, wherein obtaining information associated with one or more locations of the second function comprises sending a message associated with the second function to at least one second function manager.

9. The method according to claim 8, wherein sending a message associated with the second function comprises broadcasting said message.

10. The method according to claim 1, wherein obtaining information associated with one or more locations of the second function comprises analyzing the first function for determining a dependency on the second function.

11. A first function manager for handling a call of a second function from a first function, wherein the function manager is operable to:
obtain information associated with one or more locations of the second function;
determine an availability of the second function at the one or more locations, based on the obtained information;
select one of the one or more locations for forwarding the call of the second function from the first function; and
forward the call of the second function from the first function.

12. The first function manager according to claim 11, wherein the function manager is operable to:
intercept the call from the first function.

13. The first function manager according to claim 11, wherein determine an availability of the second function at the one or more locations comprises one or more of determine a workload of a device processing the second function, determine a distance between the one or more locations of the second function and a location of the first function, and determine an access time associated with a device processing the second function.

14. The first function manager according to claim 11, wherein forward the call of the second function from the first function comprises forward the call to a second function manager.

15. The first function manager according to claim 11, wherein obtain information associated with one or more locations of the second function comprises store information associated with a location of the second function.

16. The first function manager according to claim 15, wherein determine an availability of the second function at the one or more locations comprises retrieve the stored information associated with a location of the second function.

17. The first function manager according to claim 11, wherein obtain information associated with one or more locations of the second function comprises receive information associated with a location of the second function.

18. The first function manager according to claim 11, wherein obtain information associated with one or more locations of the second function comprises send a message associated with the second function to at least one second function manager.

19. The first function manager according to claim 18, wherein send a message associated with the second function comprises broadcast said message.

20. The first function manager according to claim 11, wherein obtain information associated with one or more locations of the second function comprises analyze the first function for determining a dependency on the second function.

21. A first function manager for handling a call of a second function from a first function, wherein the function manager comprises:
an obtaining unit for obtaining information associated with one or more locations of the second function;
a determining unit for determining an availability of the second function at the one or more locations, based on the obtained information;
a selecting unit for selecting one of the one or more locations for forwarding the call of the second function from the first function; and
a forwarding unit for forwarding the call of the second function from the first function.

22. A method performed by an arrangement for handling a call of a second function from a first function, wherein the method comprises:
obtaining information associated with one or more locations of the second function;
determining an availability of the second function at the one or more locations, based on the obtained information;
selecting one of the one or more locations for forwarding the call of the second function from the first function; and
forwarding the call of the second function from the first function.

23. The method according to claim 22, wherein the obtaining, determining, selecting, and forwarding are performed at a first function manager comprised in the arrangement.

24. The method according to claim 22, wherein the method further comprises:
receiving a function call for the second function; and
forwarding the function call to the second function.

25. The method according to claim 24, wherein the further steps of receiving and forwarding are performed at a second function manager comprised in the arrangement.

26. The method according to claim 22, wherein the method further comprises:
intercepting the call from the first function, wherein the intercepting is optionally performed by a first function manager comprised in the arrangement.

27. An arrangement for handling a call of a second function from a first function, wherein the arrangement is operable to:
obtain information associated with one or more locations of the second function;
determine an availability of the second function at the one or more locations, based on the obtained information;
select one of the one or more locations for forwarding the call of the second function from the first function; and
forward the call of the second function from the first function.

28. The arrangement according to claim 27, wherein the arrangement is further operable to:
receive a function call for the second function; and
forward the function call to the second function.

29. The arrangement according to claim 27, wherein the arrangement is further operable to:
intercept the call from the first function.

30. The arrangement according to claim 27, wherein the arrangement comprises a first function manager, a second function manager and a message bus, and is further operable to communicate between the first function manager and the second function manager via the message bus.

31.-35. (canceled)
